(19) United States
(12) Patent Application Publication
(10) Pub. No.: US 2008/0195470 A1
(43) Pub. Date: Aug. 14, 2008

(54) Automatic reposting of chronologically listed online advertisements

(75) Inventor: Carl A. Ferrer, Frisco, TX (US)

Correspondence Address: LOUIS J. HOFFMAN, P.C., 11811 North Tatum Boulevard, Suite 2100, Phoenix, AZ, 85028, US

(73) Assignee: Village Voice Media Holdings, LLC

(21) Appl. No.: 11/672,920

(22) Filed: Feb. 8, 2007

(51) Int. Cl. G06Q 10/00

(52) U.S. Cl. 705/14

(57) ABSTRACT

A method for presenting advertisements includes: receiving a multitude of advertisements from different advertisers and storing them; storing a corresponding posting date for each advertisement; automatically updating the corresponding posting date; and transmitting a list of stored advertisements in response to a request from a remote network interface device. The posting date is automatically updated after a selected time interval following the posting date. The transmitted list of stored advertisements is directed to the remote device and is displayed in reverse chronological order according to the posting dates of the advertisements. A computer-readable medium can bear computer-executable instructions for performing said method. One or more computer modules can be structured and connected to perform said method.

### BACKGROUND

The field of the present invention relates to online posting of advertisements. In particular, systems and methods are disclosed for automatic reposting of advertisements typically listed in reverse chronological order.

Several systems are currently in use for online posting of classified advertising. Internet sites offering this service include craigslist.com and backpage.com. Aside from those general sites, which offer the service in a variety of areas, the Internet may contain sites directed more specifically toward certain specialty categories, e.g., sites focused on corporate apartment or condo rentals. Some common characteristics of systems of those sorts typically can be as follows. Classified advertisements can be received from multiple advertisers and posted on a web page of an Internet site or on a series of such pages, perhaps in exchange for a fee. A list of advertisements is transmitted via the Internet to any computer on the Internet requesting such a list. Such requests often include classification or search criteria to restrict the list to those advertisements most relevant to the requestor's needs. Such criteria might include geographic criteria (city, state, etc) and ad classification (housing, items for sale, job openings, personal ads, etc). Once the criteria have been applied to retrieve a suitable list of advertisements, the list is transmitted and presented to the requester with the advertisements typically arranged in reverse chronological order (i.e., most recent first).

It has been observed that when presented with a lengthy list of search results, Internet users tend to focus only on the first few results on a web page, or only on the first few pages of results when the results are presented on multiple web pages. For the classified advertising services described above, advertisements posted more recently appear nearer to the top of the list or on the first few of many pages, and are therefore much more likely to be seen and result in a desired transaction. For an ad classification or a geographic area for which only infrequent submissions of new advertisements are received, this might not present a practical problem. For ad classifications or geographic area for which large numbers of new advertisements are received, however, any given ad is quickly “buried” as new advertisements are added to the list and may soon become effectively useless.

An advertiser can overcome this problem by manually re-posting the ad. Such a solution is time-consuming and also results in multiple copies of the same ad on the list. Multiple copies of many advertisements can add to the administrative and technologic burdens of the administrator of the classified ad system. Multiple copies of a given ad can lead to confusion or suspicion on the part of those requestors viewing the advertisements. Manual re-posting is at best a non-ideal solution to the problem. It is therefore desirable to provide systems and methods for presenting online advertising that enable a given ad to remain near the beginning of a reverse-chronological list without requiring an advertiser to manually re-post the ad.

### SUMMARY

A method for presenting advertisements comprises: (a) receiving indicia representing a multitude of advertisements from different advertisers and storing them; (b) storing indicia representing a posting date for each advertisement; (c) automatically updating the posting date for at least one advertisement; and (d) transmitting indicia representing a list of advertisements in response to a request. The indicia representing the advertisements are received at a network connection. The posting date is automatically updated after a selected time interval following the posting date. The request for advertisements is received at the network connection from a remote network interface device. The indicia representing the list of advertisements is transmitted to the network connection directed to the remote network interface device, and when received by the remote network interface device results in display of the list in reverse chronological order according to the posting dates of the corresponding advertisements. A computer-readable medium can bear computer-executable instructions for performing said method. One or more computer modules can be structured and connected for performing said method.

Objects and advantages pertaining to posting of online classified advertisements may become apparent upon referring to the exemplary embodiments illustrated in the drawings and disclosed in the following written description and/or claims.

### BRIEF DESCRIPTION OF THE DRAWINGS

FIG. 1 illustrates schematically an exemplary system for presenting advertisements online.

FIG. 2 is a flow diagram illustrating an exemplary method for presenting advertisements online.

FIGS. 3 and 4 show exemplary browser windows in which automatic re-posting of advertisements can be administered.

FIG. 5 shows an exemplary browser window in which an advertiser can select automatic re-posting parameters for an advertisement.

FIG. 6 shows an exemplary browser window in which an administrator can view automatic re-posting parameters for an online advertisement.

FIG. 7 shows an exemplary browser window in which an advertiser can add automatic re-posting to an existing advertisement.

FIG. 8 shows an exemplary browser window in which an administrator can edit automatic re-posting parameters for an advertisement.

The embodiments shown in the Figures are exemplary, and should not be construed as limiting the scope of the present disclosure and/or appended claims.

### DETAILED DESCRIPTION OF EXEMPLARY EMBODIMENTS

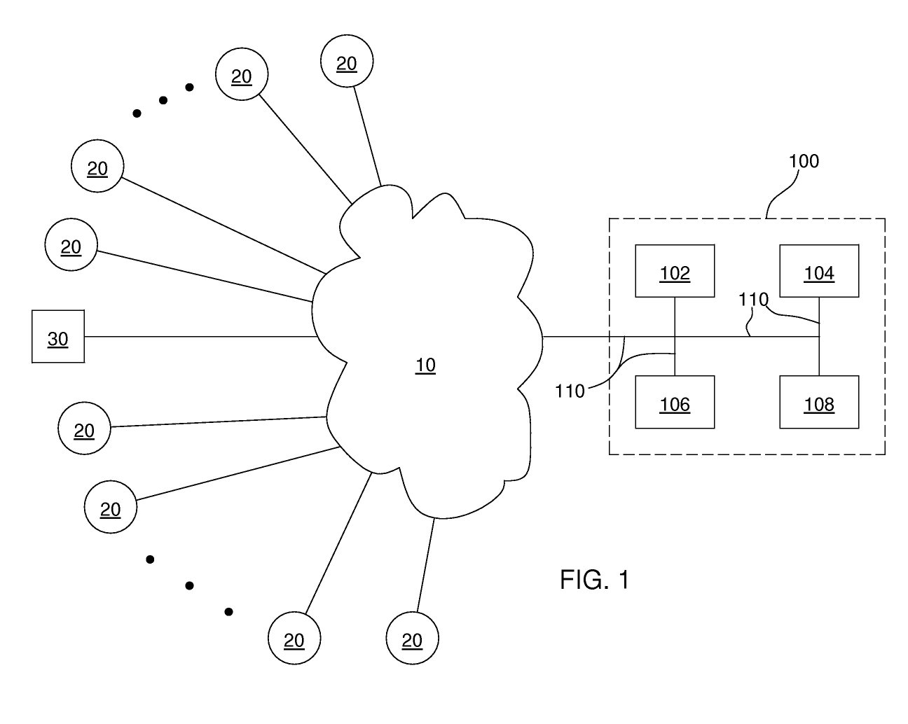

FIG. 1 illustrates schematically an exemplary system 100 for presenting advertisements online. Computer module 102 receives at network connection 110 to a computer network 10 (e.g., the Internet) indicia representing advertisements from a multitude of corresponding advertisers 20 who desire to post on a given web site and control posting on the site, and stores the received indicia. Module 102 can implement advertiser identification controls, collecting whatever information, if any, is desired about the identity and contact information of the advertiser. Module 102 can also implement or control a payment and collection system, if desired. Module 102 controls input of the content of each advertisement, either through uploading or receiving typed input, and can if desired restrict the nature of the content of the advertisement, in any of a variety of ways. For example, module 102 might be programmed to block offensive keywords, to format the advertisement in accordance with a standard format, or to request information about the proper classification of the advertisement.

Computer module 104 stores for each of the advertisements indicia representing a corresponding posting date. Typically, stored posting date indicia initially represent the date of receipt of the corresponding advertisement by computer module 102 as the posting date, but a different initial posting date can be represented if needed or desired. Computer module 106 automatically updates the posting date for at least one of the stored advertisements, after a selected time interval following the corresponding posting date. Typically, the updated posting date is that date on which the posting date is updated by module 106, but a different updated posting date can be used if needed of desired. The updating of the posting date is described in further detail below.

Computer module 108 transmits, in response to a request for advertisements received at network connection 110 from a remote network interface device 30, indicia representing a list of one or more of the advertisements. The indicia are transmitted to network connection 110 and are directed to remote network interface device 30 whence the request was received. In accordance with typical approaches for web sites of this sort, the transmitted indicia result in display of the list at remote network interface device 30 in reverse chronological order according to the posting dates (initial or updated) of the corresponding advertisements. The transmitted list of stored advertisements can include every stored advertisement, but typically includes only a subset of stored advertisements selected by module 108 based on search criteria submitted by a user as part of the request received from remote network interface device 30. Such criteria can include ad classification, keywords, geographic region, price range, or other suitable criteria. Module 108 thus controls posting of stored advertisements on a web page. Alternatively, module 108 can optionally use information received by module 102 to select one or more of a plurality of web pages on which to post each stored advertisement, such as based on the classification, geographic region, keywords, and so forth. The indicia representing the list can be transmitted in any form of encoding desired. For example, if needed, the system can rely on the presence of stored information or programs, either at the receiving device 30 or accessible to device 30, such as at a website, to allow reconstruction of the transmitted indicia into visually and/or audibly perceptible images, text, and/or links providing information about the advertised subject matter. Usually, the display would be with the assistance of browser software operating on device 30 or some other software allowing viewing of the transmitted list.

The computer modules 102, 104, 106, and 108 can comprise a single computer or server for carrying out the recited functions, or can comprise multiple computers or servers connected directly or via a computer network (e.g., network 10 or another suitable network) for carrying out the recited functions. Modules 102, 104, 106, and 108 are shown in FIG. 1 connected to each other and to computer network 10 by network connection 110. This connection topology is only one example of various connection schemes that can be employed and that fall within the scope of the present disclosure or appended claims. Examples, not all of which are shown, include (but are not limited to): multiple computer modules incorporated into single computer or server; separate connections 110 between each computer module and network 10; a local network connecting the computer modules and also serving as network connection 110 to network 10; direct connections between two of more of the computer modules with at least one module connected to network 10 via network connection 110. The modules 102, 104, 106, or 108 can be implemented as general or special purpose computers programmed through software or as hardware or equipment “programmed” through hard wiring, or a combination of the two. Computer programs, if used, can be implemented in temporary or permanent storage or in replaceable media, such as by including programming in microcode, object-oriented code, web-based or distributed software modules that operate together, RAM, ROM, CD-ROM, DVD-ROM, hard drives, thumb drives, flash memory, optical media, magnetic media, semiconductor media, or any future storage alternatives.

The computer network 10 typically comprises the Internet, but can comprise any other publicly accessible computer network, including any successors to the internet. By publicly accessible, it is not required that the system be available to all users. Rather, the system can be set to allow access to certain users, such as those who have registered, those who have previously purchased something, those employed by a particular company, and so forth. In that regard, network 10 can be a WAN or LAN in lieu of the Internet.

Network interface device 30 can comprise any device suitably structured and connected for accessing computer network 10 by any combination of wired or wireless connections, e.g., a networked computer, desktop computer or workstation, a notebook computer or workstation, a portable digital assistant (PDA), a hand-held device, a wireless phone, a data terminal, an Internet appliance (desktop, portable, or handheld), and so on.

The date on which the system receives an advertisement from the advertiser 20 is typically used as the initial posting date. It should be noted that any of the “dates” referred to herein can also include the time of day, if needed or desired. The pre-selected time interval for re-posting can be set to any suitable interval, such as every month or fraction thereof, every week or fraction thereof, every day or fraction thereof, every hour or fraction thereof, and so forth. The time interval can be a fixed parameter of the system and set to the same value for all advertisements to be re-posted, or can be an adjustable parameter that can vary among advertisements. The variation in the time interval can be based on geographic region, ad classification, advertiser preference, re-posting charge or fee, or other desired selection basis, and can be selected by the advertiser, by an administrator of the system, or automatically by any suitable algorithm. In general, it can be beneficial to select a time interval for re-posting that is commensurate with the number of new advertisements received in a given classification or geographic region. For example, monthly re-posting might be sufficient in a low-interest classification in a sparsely-populated area (e.g., used snow shoes for sale in rural Georgia), while hourly re-posting might be needed in a popular classification in a densely-populated area (e.g., apartments for rent in New York City).

The initial posting of an advertisement on the online classified advertising system can be free or can be a for-fee service. In either case, automatic re-posting of advertisements can be free or can be a for-fee service. Any suitable fee structure can be implemented, including as examples one or more of the following: charging a fee per re-posting (e.g., $1 per re-posting); charging a fee for a set of multiple re-postings (e.g., $10 per dozen re-postings); charging a fee based on the time-interval between re-postings ($1 per week for weekly re-postings or $5 per week for daily re-postings); charging a fee based on a time period during which the re-postings occur (e.g., $5 per week or $15 per month for daily re-postings).

The system can be configured to receive re-posting instructions from an advertiser along with the advertisement, or the system can be configured to receive re-posting instructions from the advertiser at a later time. The system can be configured to transmit a request for such instructions to the advertiser by way of the computer network. These instructions can include one or more of: number of re-postings, frequency of re-postings, or a time period spanned by the re-postings.

After a desired number of re-postings has been reached or a desired time period for re-postings has ended, re-postings can be discontinued automatically. At that point the corresponding advertisement can be specifically removed from the system, or can be left on the system with its last re-posting date in effect, either indefinitely or until removed by any automatic advertisement-removal procedure in place.

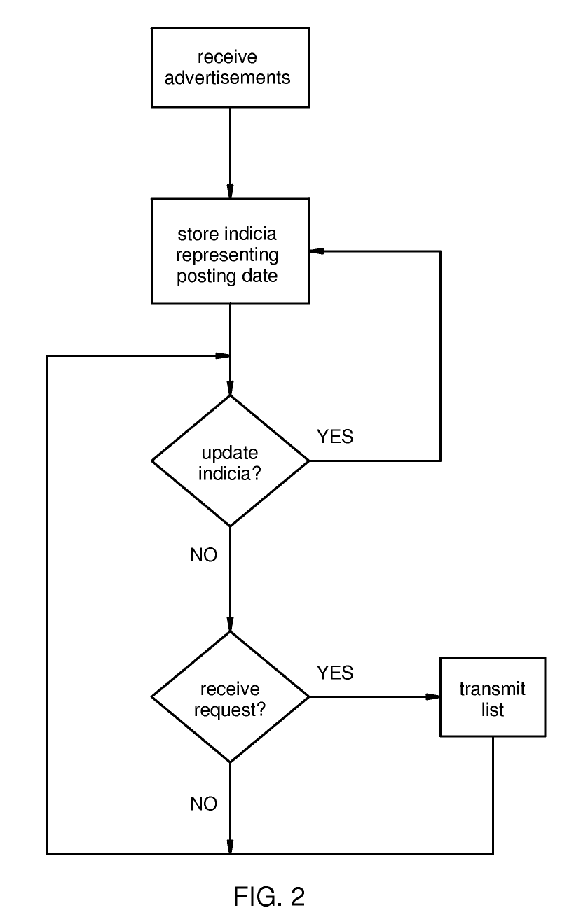

A method for presenting advertisements is illustrated schematically in the flowchart of FIG. 2 and comprises: (a) receiving a multitude of advertisements from different advertisers and storing them; (b) storing indicia representing a corresponding posting date for each advertisement; (c) automatically storing updated indicia for at least one advertisement representing the corresponding posting date; and (d) transmitting a list of stored advertisements in response to a request. The advertisements are received at a network connection. Updated indicia representing the corresponding posting date for at least one of the stored advertisements are automatically stored after a pre-selected time interval following the corresponding posting date. The request for advertisements is received at the network connection from a remote network interface device. The list of stored advertisements is transmitted to the network connection directed for delivery to the remote network interface device for display of items in the transmitted list at the remote network interface device in reverse chronological order according to the posting dates of the corresponding advertisements represented by the indicia. A computer-readable medium can bear computer-executable instructions for performing said method. One or more computers can be structured and connected for performing said method.

The re-posting of advertisements with an updated posting date can be accomplished in a variety of ways. In a first example, storing the updated indicia can comprise altering the stored indicia to represent an updated posting date. Indicia representing previous posting or re-posting dates need not be retained. None of the other data or indicia associated with the advertisement is altered or copied, and the listed item corresponding to the advertisement is displayed in reverse-chronological order according to its updated posting date (i.e., its re-posting date). In this implementation management by an advertiser involves management of only the single copy of each advertisement. The displayed list need not reveal whether, how often, or how many times the advertisement has been re-posted, but can display any of that information if needed or desired. In a second example, indicia representing at least one prior posting date are retained, but none of the other data or indicia associated with the advertisement is altered or copied. The listed item corresponding to the advertisement appears in the displayed reverse-chronological list according to its updated posting date and appears at least once in the displayed reverse-chronological list according to the prior posting date represented by the retained indicia. In this implementation management by an advertiser involves management of the single copy of each advertisement and multiple posting or re-posting dates for the advertisement. In a third example, indicia representing at least one prior posting date are retained, and an additional copy of the advertisement is stored for each prior posting date represented by retained indicia. The additional copies of the advertisement function essentially as independent advertisements, with listed items corresponding to the copies appearing in the displayed reverse-chronological list according to the posting dates represented by the updated and retained indicia. In this implementation management by an advertiser involves management of the multiple copies of each advertisement and the corresponding posting and re-posting dates.

A description of an exemplary implementation of systems and methods disclosed herein follows, which is presented for illustrative purposes only and should not be construed as limiting the scope of the present disclosure or appended claims. A series of screen shots are shown illustrating how the system can be implemented via browser software. Any other suitable user interface can be employed.

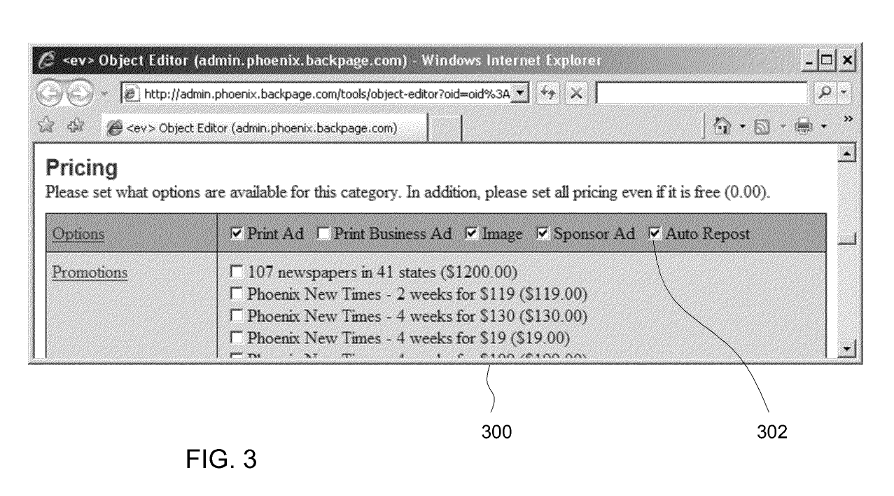

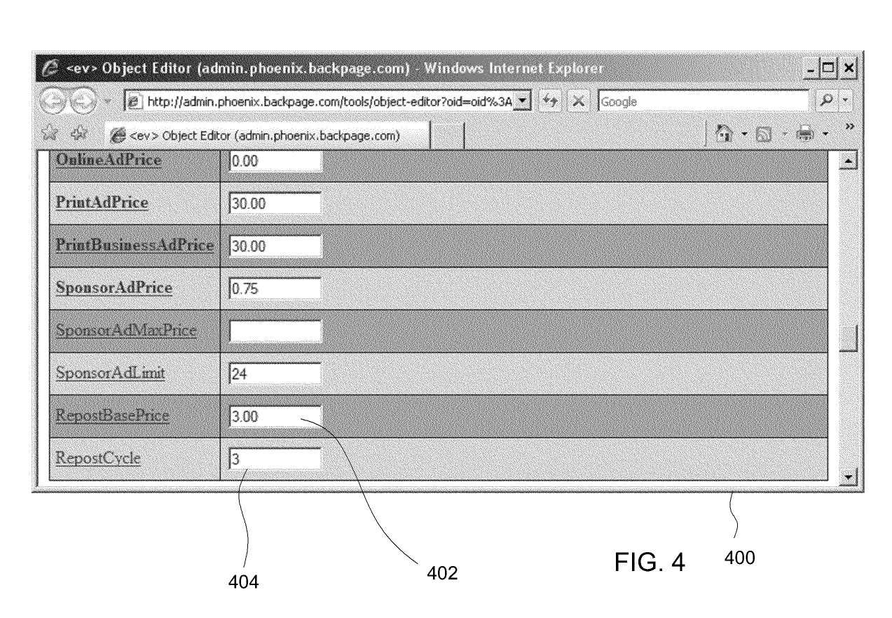

FIG. 3 shows a browser window 300 containing a web form that allows administrative set up of an advertisement category. Among the advertising options for online and print advertisements is a check box 302 for enabling automatic re-posting functionality for online advertisements. Radio buttons, numeric input, drop-down menus, check boxes, or other interface arrangements can be employed as desired. Further administrative set up is done through browser window 400 shown in FIG. 4, which includes form fields for entering parameters or prices for various advertising options. In this example, a re-post base price of $3.00 is entered into form field 402 by an administrator and a re-post cycle (i.e., re-posting interval) of three days is entered into form field 404 by an administrator. In this particular example, the re-posting interval and re-post base price are not selectable by the advertiser, but are set for each advertising category by a system administrator (who can change them later, if desired). The re-posting pricing is based on choices offered to the advertisers of 4, 8, 12, or 26 re-postings, with the advertiser being charged 1, 2, 3, or 6 times the re-posting base price, respectively. The re-posting base price may be set higher or lower by a system administrator based on a variety of factors, presumably including demand for a particular given category or type. The re-post cycle time can also be set longer or shorter by a system administrator based on a variety of factors, presumably including typical volumes of advertisements received for a given advertising category type. An automated system can substitute for the manual set-up arrangement shown to calculate pricing and reposting intervals in accordance with an algorithm based on such factors, which can be measured and monitored.

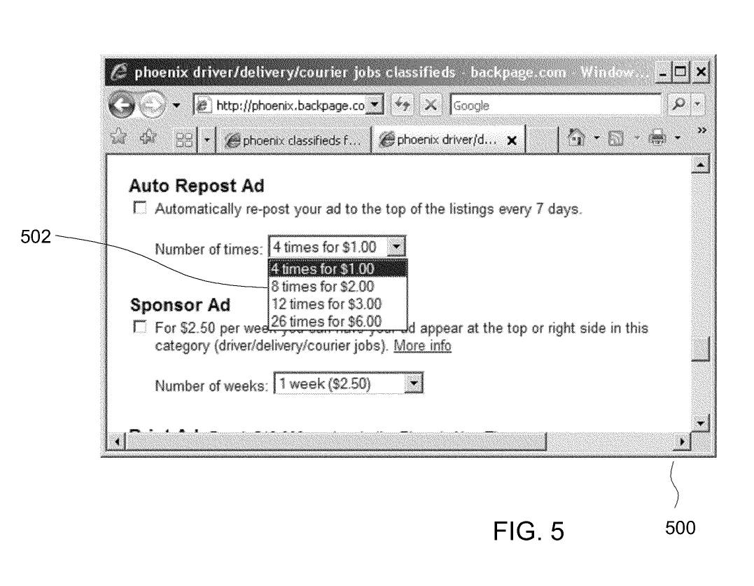

A range of specific pricing schedules can arise from the exemplary general pricing framework. In the example already given, an advertiser would pay $3 for re-posts every third day for 12 days (4 re-posts), $6 for re-posts every third day for 24 days (8 re-posts), $9 for re-posts every third day for 36 days (12 re-posts), or $18 for re-posts every third day for 78 days (26 re-posts). With the re-post base price set at $10 and the re-post interval set at one day, an advertiser would pay $10 for daily re-posts for 4 days (4 re-posts), $20 for daily re-posts for 8 days (8 re-posts), $30 for daily re-posts for 12 days (12 re-posts), or $60 for daily re-posts for 26 days (26 re-posts). With the re-post 11 base price set at $1 and the re-post interval set at seven days, an advertiser would pay $1 for re-posts every seventh day for 28 days (4 re-posts), $2 for re-posts every seventh day for 56 days (8 re-posts), $3 for re-posts every seventh day for 84 days (12 re-posts), or $6 for re-posts every seventh day for 182 days (26 re-posts). This latter pricing schedule is illustrated in the browser window 500 shown in FIG. 5, where the advertiser can select 4, 8, 12, or 26 re-posts through drop-down menu 502.

The preceding exemplary arrangement limits advertisers to selecting among 4, 8, 12, or 26 re-postings at a system-selected re-posting interval. Many other schedules can be employed, offering greater or lesser flexibility for the advertisers. At one extreme, the number of re-postings and the re-posting interval both can be fixed by the system. At the other extreme, advertisers can be allowed to choose an arbitrary number of re-postings and an arbitrary re-posting interval.

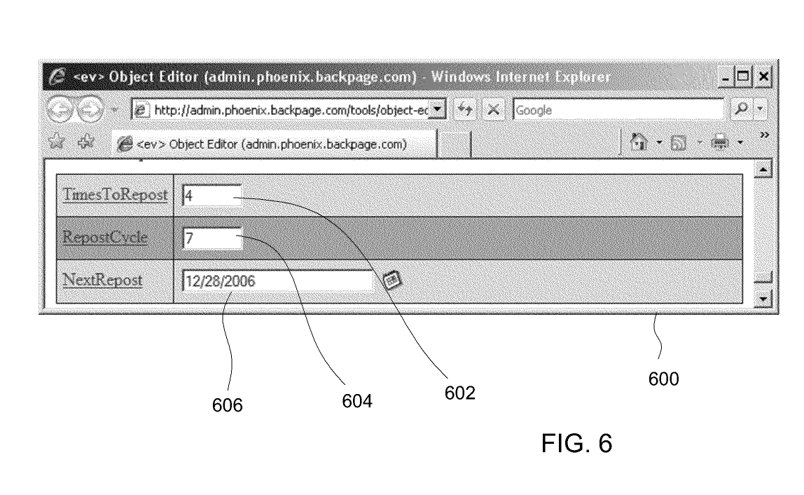

A browser window 600 is shown in FIG. 6 illustrating one exemplary arrangement for implementing the automatic re-posting method. For each advertisement for which automatic re-posting is enabled, a number of times to re-post (shown in field 602), and re-posting interval (shown in field 604), and a next re-posting date (shown in field 606) are among data stored for the advertisement. At regular intervals (presumably daily, although other suitable intervals can be used), these data are queried and analyzed. For a given advertisement, if the next re-posting date in field 606 is equal to the current date, then the indicia representing the posting date are altered to represent the current date and the number of times to re-post (field 602) is decreased by one. If the number of times to re-post in filed 602 is greater than zero, then the next re-posting date (field 606) is altered by adding the number of days in the re-posting interval field 604. If the number of times to re-post is zero, then the next re-posting date is not changed. When the indicia representing the posting date are altered, other data stored for the advertisement that depend in some way on the posting date can be altered or updated, e.g., an advertisement expiration date.

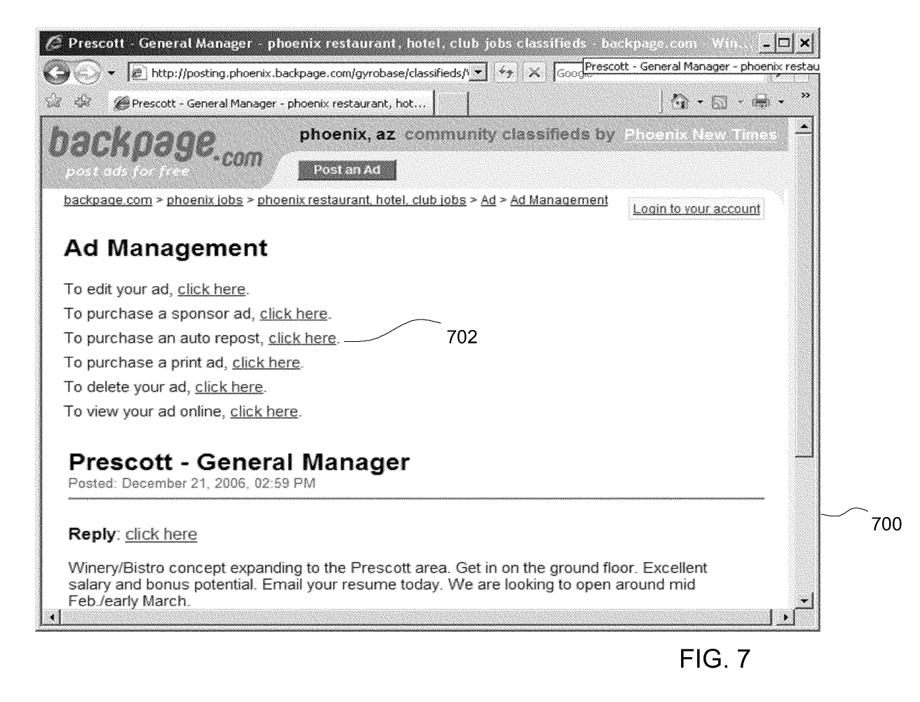

A browser window 700 is shown in FIG. 7 that enables an advertiser to edit a previously posted advertisement to include automatic re-posting. After a suitable authentication procedure for obtaining access to the advertisement, an advertiser follows link 702 in the browser window 700, which in turn leads to browser window 500 shown in FIG. 5. The advertiser can now choose to activate the automatic re-posting feature and select the desired number of re-posts with drop-down menu 502.

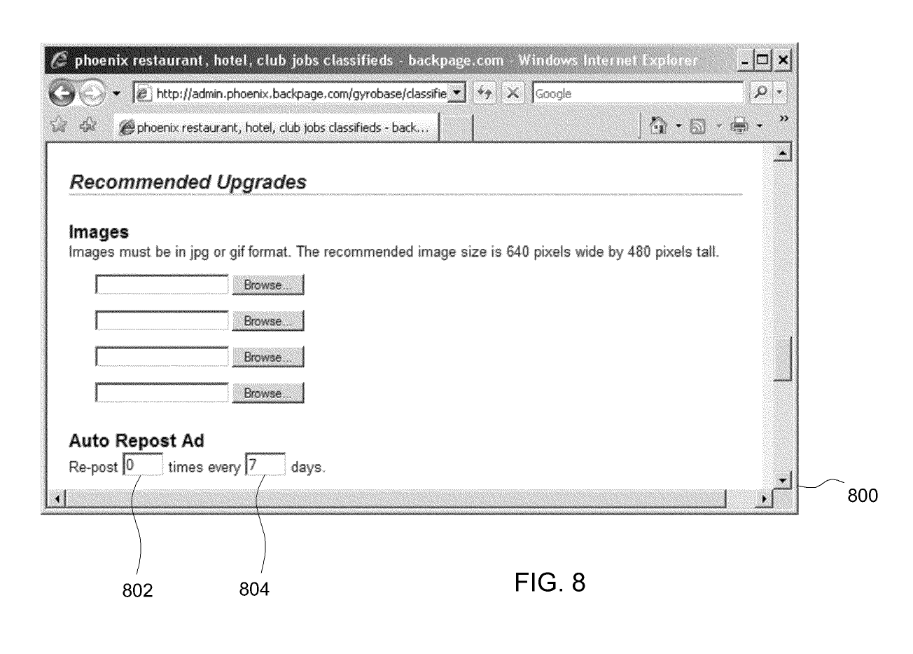

A system administrator can access the system and alter the re-posting instruction for one or more advertisements. A browser window 800 is shown in FIG. 8 in which an administrator can alter the number of re-postings at field 802 and the re-posting interval at field 804.

It is intended that equivalents of the disclosed exemplary systems and methods shall fall within the scope of the present disclosure and/or appended claims. It is intended that the disclosed exemplary systems and methods, and equivalents thereof, can be modified while remaining within the scope of the present disclosure or appended claims.

For purposes of the present disclosure and appended claims, the conjunction “or” is to be construed inclusively (e.g., “a dog or a cat” would be interpreted as “a dog, or a cat, or both”; e.g., “a dog, a cat, or a mouse” would be interpreted as “a dog, or a cat, or a mouse, or any two, or all three”), unless: i) it is explicitly stated otherwise, e.g., by use of “either . . . or”, “only one of . . . ”, or similar language; or ii) two or more of the listed alternatives are mutually exclusive within the particular context, in which case “or” would encompass only those combinations involving non-mutually-exclusive alternatives. For purposes of the present disclosure or appended claims, the words “comprising”, “including”, and “having” shall be construed as open ended terminology, with the same meaning as if the phrase “at least” were appended after each instance thereof.

What is claimed is:

1. A method for presenting advertisements, the method comprising:
(a) receiving at a network connection indicia representing a multitude of advertisements from different advertisers and storing the received advertisement indicia;
(b) for each of the advertisements, storing indicia representing its posting date;
(c) for at least one of the advertisements, after a selected time interval following that advertisement's posting date, automatically updating its posting date; and
(d) in response to a request for advertisements, received at the network connection from a remote network interface device, transmitting indicia representing a list of advertisements to the network connection directed to the remote network interface device, which when received by the remote network interface device results in display of the list at the remote network interface device in reverse chronological order according to the corresponding posting dates.

2. The method of claim 1 wherein updating the posting date comprises altering the stored posting date indicia.

3. The method of claim 1 further comprising retaining stored posting date indicia representing at least one prior posting date.

4. The method of claim 3 wherein the transmitted indicia result in at least one item appearing in the displayed list according to the updated posting date of the corresponding advertisement and appearing at least once in the displayed list according to the posting date represented by retained posting date indicia.

5. The method of claim 3 further comprising storing copies of the corresponding advertisement indicia for the posting date and for each prior posting date represented by retained posting date indicia.

6. The method of claim 1 further comprising charging a fee amount to the corresponding advertiser for automatically updating the posting date.

7. The method of claim 6 wherein the fee amount is determined at least in part by a number of times that the posting date is automatically updated.

8. The method of claim 6 wherein the fee amount is determined at least in part by the length of the selected time interval.

9. The method of claim 1 further comprising receiving at the network connection instructions of the corresponding advertiser for automatically updating the posting date.

10. The method of claim 9 wherein the instructions are received along with the corresponding advertisement indicia.

11. The method of claim 9 further comprising transmitting to the network connection, directed to the corresponding advertiser, a request for the instructions.

12. The method of claim 9 wherein the received instructions include specification of the selected time interval or specification of a number of times that the posting date is to be updated.

13. An improved method for presenting advertisements comprising: (i) receiving at a network connection indicia representing a multitude of advertisements from different advertisers and storing the received advertisement indicia; (ii) for each of the advertisements, storing indicia representing its posting date; and (iii) in response to a request for advertisements, received at the network connection from a remote network interface device, transmitting indicia representing a list of advertisements to the network connection directed to the remote network interface device, which when received by the remote network interface device results in display of the list at the remote network interface device in reverse chronological order according to the corresponding posting dates, the improvement comprising: for at least one of the advertisements, after a selected time interval following that advertisement's posting date, automatically updating its posting date.

14. The method of claim 13 wherein updating the posting date comprises altering the stored posting date indicia.

15. The method of claim 13 further comprising retaining stored posting date indicia representing at least one prior posting date.

16. The method of claim 13 further comprising charging a fee amount to the corresponding advertiser for automatically updating the posting date.

17. The method of claim 16 wherein the fee amount is determined at least in part by a number of times that the posting date is automatically updated or by the length of the selected time interval.

18. The method of claim 13 further comprising receiving at the network connection instructions of the corresponding advertiser for automatically updating the posting date, wherein the received instructions include specification of the selected time interval or specification of a number of times that the posting date is to be updated.

19. A computer-readable storage medium bearing computer-executable instructions for performing a method for presenting advertisements, the method comprising:
(a) receiving at a network connection indicia representing a multitude of advertisements from different advertisers and storing the received advertisement indicia;
(b) for each of the advertisements, storing indicia representing its posting date;
(c) for at least one of the advertisements, after a selected time interval following that advertisement's posting date, automatically updating its posting date; and
(d) in response to a request for advertisements, received at the network connection from a remote network interface device, transmitting indicia representing a list of advertisements to the network connection directed to the remote network interface device, which when received by the remote network interface device results in display of the list at the remote network interface device in reverse chronological order according to the corresponding posting dates.

20. The medium of claim 19 wherein updating the posting date comprises altering the stored posting date indicia.

21. The medium of claim 19 wherein the method further comprises retaining stored posting date indicia representing at least one prior posting date.

22. The medium of claim 19 wherein the method further comprises charging a fee amount to the corresponding advertiser for automatically updating the posting date.

23. The medium of claim 22 wherein the fee amount is determined at least in part by a number of times that the posting date is automatically updated or by the length of the selected time interval.

24. The medium of claim 19 further comprising receiving at the network connection instructions of the corresponding advertiser for automatically updating the posting date, wherein the received instructions include specification of the selected time interval or specification of a number of times that the posting date is to be updated.

25. A system for presenting advertisements, the system comprising:
(a) a computer module structured and connected to receive at a network connection indicia representing a multitude of advertisements from different advertisers and to store the received advertisement indicia;
(b) a computer module structured and connected to store indicia representing a posting date for each of the advertisements;
(c) a computer module structured and connected to update automatically, for at least one of the advertisements, after a selected time interval following that advertisement's posting date, its posting date; and
(d) a computer module structured and connected to transmit, in response to a request for advertisements, received at the network connection from a remote network interface device, indicia representing a list of advertisements to the network connection directed to the remote network interface device, which when received by the remote network interface device results in display of the list at the remote network interface device in reverse chronological order according to the corresponding posting dates.

26. The system of claim 25 wherein updating the posting date comprises altering the stored posting date indicia.

27. The system of claim 25 further comprising a computer module structured and connected to retain stored posting date indicia representing at least one prior posting date.

28. The system of claim 25 further comprising a computer module structured and connected to charge a fee amount to the corresponding advertiser for automatically updating the posting date.

29. The system of claim 28 wherein the fee amount is determined at least in part by a number of times that the posting date is automatically updated or by the length of the selected time interval.

30. The system of claim 25 further comprising a computer module structured and connected to receive at the network connection instructions of the corresponding advertiser for automatically updating the posting date, wherein the received instructions include specification of the selected time interval or specification of a number of times that the posting date is to be updated.
